(19) United States
(12) Patent Application Publication
(10) Pub. No.: US 2020/0148183 A1
(43) Pub. Date: May 14, 2020

(54) BRAKING SYSTEM FOR A MOTOR VEHICLE AS WELL AS METHOD FOR OPERATING A BRAKING SYSTEM

(71) Applicant: AUDI AG, Ingolstadt (DE)

(72) Inventor: Tobias BROK, Kösching (DE)

(73) Assignee: AUDI AG, Ingolstadt (DE)

(21) Appl. No.: 16/675,539

(22) Filed: Nov. 6, 2019

(30) Foreign Application Priority Data
Nov. 14, 2018 (DE) 10 2018 219 411.4

(51) Int. Cl. B60T 13/18; B60T 13/68; B60T 13/16

(52) U.S. Cl. CPC B60T 13/18; B60T 13/686; B60T 2270/402; B60T 2270/413; B60T 13/168

(57) ABSTRACT

A braking system for a motor vehicle, having at least one brake pressure source and at least one wheel brake. In this case, it is provided that the at least one wheel brake is fluidically connected to the at least one brake pressure source via several brake pressure control devices, which are fluidically connected in parallel, wherein each of the brake pressure control devices has at least one pressure build-up valve and at least one pressure reduction valve, and that the brake pressure control devices are fluidically connected to the at least one brake pressure source via a common valve device, wherein the valve device always fluidically connects one of the brake pressure control devices to the at least one brake pressure source. The disclosure further relates to a method for operating a braking system for a motor vehicle.

### FIELD

The disclosure relates to a braking system for a motor vehicle, having at least one brake pressure source and at least one wheel brake. The invention further relates to a method for operating a braking system for a motor vehicle.

### BACKGROUND

Publication DE 10 2015 208 148 A1, for example, is known from the prior art. This document describes a braking system for a motor vehicle for hydraulically actuating wheel brakes, having a first electrically controllable pressure source for providing a brake pressure for actuating the wheel brakes, an electrically controllable pressure modulation device for adjusting wheel-individual brake pressures for the wheel brakes with an electrically actuatable inlet valve and an electrically actuatable outlet valve for each wheel brake, and a second electrically controllable pressure source for providing a brake pressure for actuating the wheel brakes, comprising a motor-pump unit with an at least two-circuit hydraulic pump and at least one low-pressure accumulator, wherein the low-pressure accumulator is connected to an output connection of at least one outlet valve.

In this case, a first electrical energy supply unit and a second electrical energy supply unit, which is independent of the first electrical energy supply unit, are provided, wherein the first pressure source can be provided with electrical energy by the first energy supply unit, the second pressure source can be supplied with electrical energy by the second energy supply unit, and the pressure modulation device can be supplied with electrical energy by the first energy supply unit and the second energy supply unit.

### SUMMARY

The object of the invention is to propose a braking system for a motor vehicle, which has advantages over the known braking systems, in particular which enables safe operation of the braking system, particularly a fail-operational behavior, even in the event of a fault.

In this case, it is provided that the at least one wheel brake is fluidically connected to the at least one brake pressure source via several brake pressure control devices, which are fluidically connected in parallel, wherein each of the brake pressure control devices has at least one pressure build-up valve and at least one pressure reduction valve, and that the brake pressure control devices are fluidically connected to the at least one brake pressure source via a common valve device, wherein the valve device always fluidically connects one of the brake pressure control devices to the at least one brake pressure source.

The braking system is used to decelerate the motor vehicle, that is to provide a braking force acting on at least one wheel of a motor vehicle. The braking force is applied to the at least one wheel with the assistance of the at least one wheel brake. Preferably, the braking system has several wheel brakes, wherein each of the wheel brakes is assigned to one of several wheels of the motor vehicle. Thus, the braking system preferably has wheel brakes for several wheels of the motor vehicle. For example, an actual brake pressure, which applies an actual braking force to the wheel, is applied to the wheel brakes upon the actuation of a control element. The braking system is preferably present as a service brake of the motor vehicle or forms at least one component of the service brake.

The braking system has the brake pressure source for providing the actual brake pressure to the at least one wheel brake. Thus, the actual brake pressure can be built up at the wheel brake with the assistance of the brake pressure source. To this end, the at least one wheel brake is fluidically connected to the brake pressure source. The brake pressure source, for example, is in the form of a brake master cylinder, in which a brake master piston is arranged in a moveable manner, or has at least one such piston. The brake master piston adjoins, together with the brake master cylinder, a brake fluid volume, which is variable, wherein its size depends on the setting of the brake master piston. The brake master piston is coupled with the control element, which is present, for example, as a brake pedal. Via the control element, the driver of the motor vehicle can set as a desired braking force, which is also characterized as a target braking force and is preferably in fixed relationship with a default brake pressure at the at least one wheel brake. Additionally or alternatively, the brake pressure source may have a brake pump or the like, by means of which an automatic provision of the brake pressure can occur.

Typically, the at least one brake pressure source is fluidically connected to the at least one wheel brake via at least one brake pressure control device. The actual brake pressure applied at the at least one wheel brake can be set to a target brake pressure with a pressure build-up valve and a pressure reduction valve of the brake pressure control device. The target brake pressure preferably corresponds to the default brake pressure.

If there is a defect in the brake pressure control device or if the brake pressure control device cannot be supplied with sufficient electric current, for example by an electrical system of the motor vehicle, the actual brake pressure cannot be built up at the wheel brake and correspondingly no deceleration of the motor vehicle is effected. Because typically several wheel brakes, particularly all wheel brakes, of the motor vehicle are fluidically connected to the at least one brake pressure source via the brake pressure control device, a reliable deceleration of the motor vehicle is not possible with such a fault in the brake pressure control device and/or insufficient energy supply to the brake pressure control device.

For this reason, it is provided that several brake pressure control devices are arranged, with optimized flow, between the at least one wheel brake and the at least one brake pressure source, said brake pressure control devices being fluidically connected in parallel. This means that each of the several brake pressure control devices is fluidically connected, on one hand, to the at least one brake pressure source and, on the other hand, to the at least one wheel brake. Each of the brake pressure control devices then has at least one pressure build-up valve and at least one pressure reduction valve—precisely as the previously described individual brake pressure control device. The pressure build-up valve is used to supply a brake fluid provided by the brake pressure source to the wheel brake, and the pressure reduction valve is used to discharge brake fluid from the wheel brake, preferably back in the direction of the brake pressure source. The pressure build-up valve is preferably designed as a currentless open switching valve, and the pressure reduction valve is designed as a currentless closed switching valve.

The common valve device is arranged, with optimized flow, between the brake pressure control devices and the at least one brake pressure source. All brake pressure control devices are fluidically connected to the at least one brake pressure source via said valve device. One of the brake pressure control devices is always fluidically connected to the at least one brake pressure source with the assistance of the valve device such that, in the end, the at least one wheel brake is fluidically connected to the brake pressure source via said brake pressure control device and/or is in contact with the brake pressure source.

The valve device is preferably designed such that always only one of the brake pressure control devices is fluidically connected to the at least one brake pressure source. This ensures that not several or all of the brake pressure control devices have to be actuated in parallel in order to adjust the actual brake pressure at the at least one wheel brake. Of course, it may also be provided, however, that the valve device always fluidically connects several of the brake pressure control devices to the brake pressure source such that the wheel brake is connected to the brake pressure source via these several brake pressure control devices.

The valve device is present as a switching valve device and has at least one switching valve, by means of which the flow connection between the brake pressure source and at least one of the brake pressure control devices can be adjusted. For example, in a first switch position of the switching valve of the valve device, there is a flow connection between the brake pressure source and a first of the brake pressure control devices and, in a second switch position, there is a flow connection between the brake pressure source and a second of the brake pressure control devices. In the first switch position, the flow connection between the brake pressure source and the second brake pressure control device is interrupted and, in the second switch position, the flow connection between the brake pressure source and the first brake pressure device is interrupted such that, in each of the switch settings, precisely one of the brake pressure control devices is fluidically connected to the brake pressure source.

It should be noted that statements for the brake pressure source can always also be applied to the at least one brake pressure source and vice versa. Similarly, statements for the wheel brake can be applied to the at least one wheel brake and vice versa. Preferably, the statements for the brake pressure source and/or the at least one brake pressure source always apply to any of several brake pressure sources and/or the statements for the wheel brake and/or the at least one wheel brake always apply to any of several wheel brakes, provided they are present.

The described design of the braking system enables the implementation of a reliable fallback level such that reliable deceleration of the motor vehicle is always possible. To this end, there is switchover between the pressure control devices by means of the valve device until there is a functional one of the brake pressure control devices between the brake pressure source and the wheel brake with optimized flow. Subsequently, the actual brake pressure is set at the wheel brake by means of this functional brake pressure control device, particularly set to the target brake pressure.

A further design of the invention provides that the at least one pressure build-up valve and the at least one pressure reduction valve are assigned to a brake circuit. and each of the brake pressure control devices has at least one further pressure build-up valve and at least one further pressure reduction valve, which are assigned to a further brake circuit, wherein the brake circuit and the further brake circuit, fluidically independently of one another, are fluidically connected to the at least one brake pressure source via the valve device. The braking system is designed as a multi-circuit braking system in this regard. To this end, it has the brake circuit and the further brake circuit.

The at least one wheel brake is fluidically connected to the brake pressure source via the brake circuit, and the at least one further wheel brake is connected via the further brake circuit. For example, several wheel brakes are connected to the brake pressure source via the brake circuit and the further brake circuit and, in this respect, can be exposed to brake fluid provided by the brake pressure source via the respective brake pressure control device. The brake circuit and the further brake circuit of each of the brake pressure control devices are fluidically connected, fluidically independently of each other, to the brake pressure source. This takes place via the valve device.

Each of the brake circuits, that is both the brake circuit and also the further brake circuit, is fluidically connected or can be fluidically connected to the brake pressure source via the valve device, particularly solely via the valve device. It is clear that the brake pressure control devices are provided and formed for the response of several wheel brakes such that each of the brake pressure control devices in isolation enables a full-featured operation of the braking system. Thus, a high degree of redundancy is achieved with the assistance of the several brake pressure control devices.

A preferred refinement of the invention provides that the wheel brake is fluidically connected to the brake pressure source via the brake circuit of the brake pressure control devices, and a further wheel brake is fluidically connected to the brake pressure source via the further brake circuit of the brake pressure control devices. Reference has previously been made thereto. The brake circuit is intended and formed for the operation of the wheel brake and the further brake circuit is intended and formed for the operation of the further wheel brake such that several wheel brakes can be actuated by means of each of the brake pressure control devices. The previously mentioned high degree of redundancy is hereby achieved.

A further embodiment of the invention provides that, for each of the brake pressure control devices, the pressure build-up valve is fluidically connected to the at least one brake pressure source via an isolation valve of the respective brake pressure control device, and the pressure reduction valve is fluidically connected to the at least one brake pressure source via a further isolation valve of the respective brake pressure control device. Each of the pressure control devices has an isolation valve as well as a further isolation valve in this regard. The isolation valve is fluidically arranged between the pressure build-up valve and the brake pressure source, particularly between the pressure build-up valve and the valve device. Similarly, the further isolation valve is fluidically arranged between the pressure reduction valve and the brake pressure source, particularly between the pressure reduction valve and the valve device.

For example, the isolation valve and the further isolation valve are connected, on one hand, to the brake pressure source, namely preferably via the valve device. On the other hand, the isolation valve is fluidically connected to the pressure build-up valve, but fluidically separated from the pressure reduction valve, that is connected to it via the wheel brake in any case. Similarly, the further isolation valve is fluidically connected to the pressure reduction valve, but fluidically separated from the pressure build-up valve, namely preferably connected to it only via the wheel brake.

Preferably, the brake circuit as well as the further brake circuit—if provided—has such an isolation valve as well as such a further isolation valve. Preferably, the isolation valve is designed as a currentless open switching valve, and the further isolation valve is designed as a currentless closed switching valve. The described design of the brake pressure control devices with the isolation valve and the further isolation valve enables the fluidic coupling or decoupling of the respective brake pressure control device from the brake pressure source.

Within the scope of a further embodiment of the invention, it may be provided that each of the brake pressure control devices has at least one brake pump, the intake side of which is fluidically connected to the wheel brake via the respective pressure reduction valve and the pressure side of which is fluidically connected to the wheel brake via the respective pressure build-up valve. The brake pump is used to convey brake fluid in the direction of the respective wheel brake in order to build up the actual brake pressure at the wheel brake. In this respect, the brake pump represents a further brake pressure source, which is different from the brake pressure source. The intake side of the brake pump is fluidically connected to the wheel brake via the pressure reduction valve such that, by means of the brake pump, brake fluid coming from the wheel brake can be accommodated and conveyed in the direction of its pressure side. The wheel brake, in turn, is fluidically connected to the pressure side, namely via the corresponding pressure build-up valve. When the pressure built-up valve is open, brake fluid can be supplied to the wheel brake with the assistance of the brake pump.

Because each of the brake pressure control devices has the at least one brake pump, the braking system is present as an electrohydraulic braking system. This means that, in at least one operating mode of the braking system, the brake fluid present in the brake fluid volume does not directly provide the actual brake pressure present at the respective wheel brake, or provides a part of it in any case, upon an actuation of the control element. Rather, it is provided that, upon an actuation of the control element, a target brake pressure is to be determined, wherein this can take place with the assistance of at least one sensor, which is assigned to the control element and/or the brake master piston and/or the brake master cylinder.

The sensor may be designed as a displacement sensor or a pressure sensor. In the former case, the control element actuating distance by which the control element is displaced during its actuation, for example, is determined. Additionally or alternatively, the pressure present in the brake master cylinder can obviously be determined by means of a pressure sensor. Subsequently, the target brake pressure is determined from the variables measured with the assistance of the sensor, that is, for example, the displacement and/or the pressure. Following this, an actual brake pressure, which corresponds to the target brake pressure, is applied and/or set at the wheel brake.

The actual brake pressure is at least partially provided in this case by means of the brake pump, which is preferably present in the form of an electrically operated pump. In the previously described operating mode of the braking system, thus the brake pressure source is not or at least not directly connected and/or fluidically connected to the wheel brake. In order to still provide the driver of the motor vehicle with a haptic response via the control element, a braking force simulator can be assigned to the brake master cylinder. With use of the brake pump, it may also be provided to supply the brake fluid provided to the wheel brake partially by means of the brake pump and partially by means of the brake pressure source, that is the brake master cylinder for example. Such a design of the braking system assures a flexible and reliable operation of the braking system.

A further embodiment of the invention provides that the pressure side of the brake pump is fluidically connected to the brake pressure source via the isolation valve, and the intake side of the brake pump is fluidically connected to the brake pressure source via the further isolation valve. In other words, preferably the pressure side of the brake pump is connected to the brake pressure source via the isolation valve and also connected to the wheel brake via the pressure build-up valve. The intake side of the brake pump, on the other hand, is preferably fluidically connected to the brake pressure source via the further isolation valve and also fluidically connected to the wheel brake via the pressure reduction valve. The isolation valve and the further isolation valve enable a fluidic decoupling of the respective brake pressure control device or the several brake pressure control devices from the brake pressure source such that the actual brake pressure to be built up at the wheel brake, for example, is provided solely by means of the wheel brake. An autonomous driving mode of the motor vehicle can hereby be implemented without interaction of a driver such that, in turn, an extremely flexible operation is assured.

A further embodiment of the invention provides that the brake pressure control devices are connected to different electrical circuits, wherein the valve device switches from the first brake pressure control device to a second of the brake pressure control devices in the absence of current in one of a first of the electrical circuits assigned to a first of the brake pressure control devices. The first brake pressure control device is electrically connected to the first electrical circuit, and the second brake pressure control device is electrically connected to a second of the electrical circuits. This means that the first brake pressure control device is supplied with electrical energy from the first electrical circuit, and the second brake pressure control device is supplied with electrical energy from the second electrical circuit.

Preferably, the first brake pressure control device is initially fluidically connected to the brake pressure source by means of the valve device, while the second brake pressure control device is fluidically decoupled therefrom. The actuation of the wheel brake in this case initially takes place by means of the first brake pressure control device. In the event of power failure in the first electrical circuit, from which the first brake pressure control device is supplied with electrical energy, there is a switchover, with the assistance of the valve device, from the first brake pressure control device to the second brake pressure control device, which is supplied with electrical energy from the second electrical circuit independently of the first electrical circuit.

To this end, the valve device or a corresponding switching valve of the valve device is preferably connected to the first electrical circuit and simultaneously designed such that there is a switch from the first brake pressure control device to the second brake pressure control device autonomously in the absence of current of the valve device and/or of the respective control valve. A fallback level is hereby implemented in a reliable and simple form and manner.

A refinement of the invention provides that the brake pressure control devices comprise at least three brake pressure control devices, and the valve device is multistage, wherein a first stage of the valve device is fluidically connected to the at least one brake pressure source on the input side and to the first brake pressure control device and a second stage of the valve device on the output side, and the second stage of the valve device is connected to the first stage of the valve device on the input side and to the second brake pressure control device and a third of the brake pressure control devices on the output side.

Two fallback levels are implemented with the assistance of the brake pressure control devices. The valve device is designed as multistage and, to this end, has the first stage and the second stage. Both may be present in the form of a switching valve, for example in the form of a 4/2-way valve such that the valve device as a whole is present as an 8/3-way valve. The valve device is connected to the brake pressure source on the input side and to the three brake pressure control devices on the output side, preferably to both the brake circuit and the further brake circuit (if present).

The first stage of the valve device and/or the corresponding switching valve is electrically connected, for example, to the same electrical circuit as the first brake pressure control device. The second stage of the valve device and/or the corresponding switching valve is preferably connected to the same electrical circuit as the second brake pressure control device.

The first stage is designed such that it connects to the brake pressure source when the first brake pressure control device is energized, and the second stage of the valve device connects to the brake pressure source in the absence of current. The second stage and/or the corresponding switching valve is designed such that it fluidically connects the second brake pressure control device to the brake pressure source when energized and fluidically connects the third brake pressure control device to the brake pressure source in the absence of current. A high level of operating safety is hereby achieved.

Finally, within the scope of a further design of the invention, a provision may be that the brake pressure control devices are present as equivalent parts. In other words, the brake pressure control devices are designed identically such that they can be economically provided in high quantity. Due to the use of the brake pressure control devices present as equivalent parts, a new design of a brake pressure device, which already inherently provides the described fallback levels, is avoided and the braking system can be constructed extremely economically in this respect.

The invention further relates to a method for operating a braking system for a motor vehicle, particularly a braking system according to the statements within the scope of this description, wherein the braking system has at least one brake pressure source and at least one wheel brake. In this case, it is provided that the at least one wheel brake is fluidically connected to the at least one brake pressure source via several brake pressure control devices, which are fluidically connected in parallel, wherein each of the brake pressure control devices has at least one pressure build-up valve and at least one pressure reduction valve, and that the brake pressure control devices are fluidically connected to the at least one brake pressure source via a common valve device, wherein the valve device always fluidically connects one of the brake pressure control devices to the at least one brake pressure source.

Reference has already been made to the advantages of such type of procedure and/or such type of design of the braking system. Both the braking system as well as the method for the operation thereof may be further refined according to the statements within the scope of this description, to the extent that reference is made to them.

### BRIEF DESCRIPTION OF THE DRAWING

The disclosure is explained in more detail in the following by exemplary embodiments, without limiting the invention. In doing so, the only

FIG. 1 shows a schematic representation of a braking system for a motor vehicle.

### DETAILED DESCRIPTION

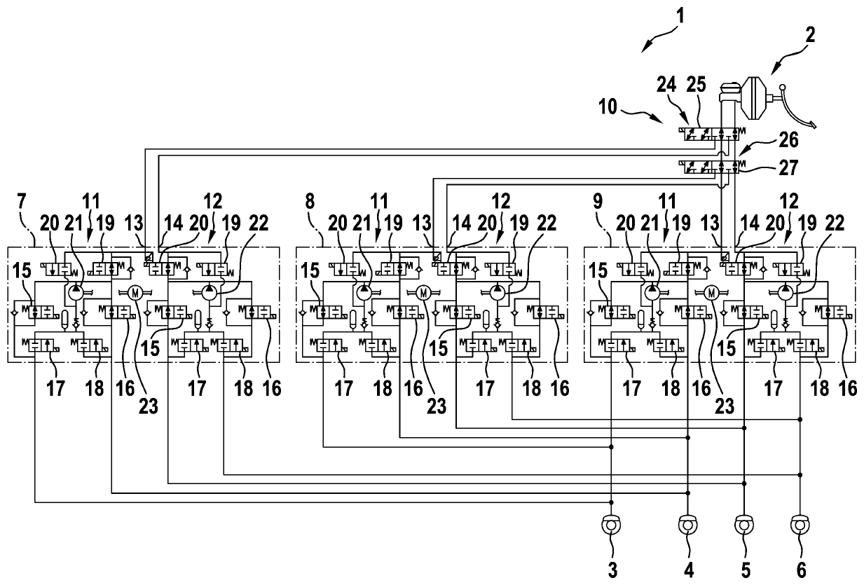

The FIG. 1 shows a schematic representation of a braking system 1 for a motor vehicle. The braking system 1 has at least one brake pressure source 2 as well as at least one wheel brake 3, several wheel brakes 3, 4, 5, and 6 in the exemplary embodiment shown here, as essential components. The wheel brakes 3, 4, 5, and 6 are fluidically connected to the brake pressure source 2, namely via brake pressure control device 7, 8, and 9, which are fluidically connected in parallel, as well as via a common valve device 10. The wheel brakes 3, 4, 5, and 6 are subsequently also designated as the first wheel brake 3, second wheel brake 4, third wheel brake 5, and fourth wheel brake 6, and the brake pressure control devices 7, 8, and 9 are also designated as the first brake pressure control device 7, second brake pressure control device, and third brake pressure control device 9.

Each of brake pressure control devices 7, 8, and 9 has a brake circuit 11 as well as a further brake circuit 12. Two wheel brakes 3, 4, 5, and 6 are fluidically connected to each of the brake circuits 11 and 12 of each of brake pressure control devices 7, 8, and 9. Thus, wheel brakes 3 and 4 are fluidically connected to the first brake circuit 11 of the brake pressure control device 7, 8, and 9, and wheel brakes 5 and 6 are fluidically connected to the second brake circuit 12 of brake pressure control device 7, 8, and 9.

Each brake circuit 11 and 12 has a separate input 13 and/or 14 of respective brake pressure control device 7, 8, and 9. Inputs 13 and 14 of brake pressure control device 7, 8, and 9 are each connected to the brake pressure source 2 independently of one another, namely via the valve device 10. The valve device 10 has outputs for each of inputs 13 and each of inputs 14, that is six outputs in total. The valve device 10 has two inputs on the input side, which are fluidically connected to the brake pressure source 2 separately from one another. As a whole, the braking system 1 is thus designed as a multi-circuit, particularly as a two-circuit, braking system 1.

Each brake circuit 11 and 12 of each of brake pressure control devices 7, 8, 9 has several pressure build-up valves 15 and 16 as well as several pressure reduction valves 17 and 18. Pressure build-up valves 15 and 16 are preferably each designed as currentless open switching valves, and pressure reduction valves 17 and 18 are each designed as currentless closed switching valves. In the case of the first brake circuit 11, the pressure build-up valve 15 and the pressure reduction valve 17 are fluidically connected to wheel brake 3, and in the case of the second brake circuit, they are fluidically connected to wheel brake 5. In the case of the first brake circuit 11, the pressure build-up valve 16 and the pressure reduction valve 17 are fluidically connected to the second wheel brake 4, and in the case of the second brake circuit 12, they are fluidically connected to the fourth wheel brake 6. For example, wheel brakes 3 and 4 are assigned to a front wheel axle, and wheel brakes 5 and 6 are assigned to a rear axle of the motor vehicle. In this case, wheel brakes 3 and 5, for example, are assigned to a first track, and wheel brakes 4 and 6 are assigned to a second track different from the first track.

Each brake circuit 11 and 12 of each of brake pressure control devices 7, 8, and 9 has an isolation valve 19 and a further isolation valve 20. For each of brake circuits 11 and 12, pressure build-up valves 15 and 16 are fluidically connected to the respective input 13 and/or 14 via isolation valve 19, and pressure reduction valves 17 and 18 are fluidically connected to the respective input via isolation valve 20, with the fluid connection also being to the brake pressure source 2 and/or the valve device 10 at the same time. In addition, a brake pump 21 and/or 22 is assigned to each of the brake circuits 11 and 12, wherein brake pumps 21 and 22 of each brake pressure control device 7, 8 and 9 are driven or can be driven by a common motor 23. A pressure side of the respective brake pump 21 and/or 22 is fluidically connected to the respective input 13 and/or 14 and, with them, to the brake pressure shaft 2 via the respective isolation valve 19, and an intake side of the respective brake pump 21 and/or 22 is fluidically connected to the brake pressure shaft 2 via corresponding isolation valve 20, said fluid connection, in turn, being via the valve device 10.

In the exemplary embodiment shown here, the valve device 10 is constructed to be multistage and has, in this respect, a first stage 24 with a first switching valve 25 and a second stage 26 with a second switching valve 27. The two switching valves 25 and 27 are each designed as a 6/2-way valve such that the valve device 10 as a whole is present as an 8/3-way valve. The first switching valve 25 is connected to the brake pressure shaft 2 on the input side and connected to the brake pressure control device 7 on the output side as well as to the second switching valve 27. The second switching valve 27 in this respect is connected to the first switching valve 25 on the input side. The second switching valve 27 is connected to brake pressure control device 8 and to brake pressure control device 9 on the output side.

In a first switch position of the first switching valve 25, the brake pressure source 2, in this respect, is fluidically connected to brake pressure control device 7 via the valve device 10. In contrast, in a second switch position of the first switching valve 25, the brake pressure source 2 is fluidically connected to the second switching valve 27. In a first switch position of the second switching valve 27, switching valve 25 is fluidically connected to brake pressure control device 8, and in a second switch position, it is fluidically connected to brake pressure control device 9. If the first switching valve 25 is in its second switch position, the brake pressure source 2 is thus fluidically connected to brake pressure control device 8 in the first switch position of the second switching valve, and said brake pressure source is fluidically connected to brake pressure control device 9 in the second switch position of the second switching valve 27.

Switching valves 25 and 27 are each designed such that they are present without current in their second switch position. Preferably, the first switching valve 25 is connected to the same electrical circuit as the first brake pressure control device 7. In contrast, the second switching valve 27 is preferably connected to the same electrical circuit as brake pressure control device 8. Brake pressure control devices 7, 8, and 9 are especially preferably connected to electrical circuits separate from one another, that is the first brake pressure control device 7 is connected to a first electrical circuit, the second brake pressure control device 8 is connected to a second electrical circuit, and the third brake pressure control device 9 is connected to a third electrical circuit. A fallback level for the braking system 1 is hereby achieved in an especially reliable form and manner in event of failure of one of the brake pressure control devices 7, 8, and 9 and/or one of the corresponding electrical circuits.

1. A braking system for a motor vehicle, comprising:
at least one brake pressure source and at least one wheel brake, wherein the at least one wheel brake is fluidically connected to the at least one brake pressure source via several brake pressure control devices, which are fluidically connected in parallel,
wherein each of the brake pressure control devices has at least one pressure build-up valve and at least one pressure reduction valve, and that the brake pressure control devices are fluidically connected to the at least one brake pressure source via a common valve device,
wherein the valve device always fluidically connects one of the brake pressure control devices to the at least one brake pressure source.

2. The braking system according to claim 1, wherein the at least one pressure build-up valve and the at least one pressure reduction valve are assigned to a brake circuit and each of the brake pressure control devices has at least one further pressure build-up valve and at least one further pressure reduction valve, which are assigned to a further brake circuit, wherein the brake circuit and the further brake circuit, fluidically independently of one another, are fluidically connected to the at least one brake pressure source via the valve device.

3. The braking system according to claim 1, wherein the wheel brake is fluidically connected to the brake pressure source via the brake circuit of the brake pressure control device, and a further wheel brake is fluidically connected to the brake pressure source via the further brake circuit of the brake pressure control devices.

4. The braking system according to claim 1, wherein, for each of the brake pressure control devices, the pressure reduction valve is fluidically connected to the at least one brake pressure source via an isolation valve of the respective brake pressure control device, and the pressure reduction valve is fluidically connected to the at least one brake pressure source via a further isolation valve of the respective brake pressure control device.

5. The braking system according to claim 1, wherein each of the brake pressure control devices has at least one brake pump, the intake side of which is fluidically connected to the wheel brake via the respective pressure reduction valve, and the pressure side of which is fluidically connected to the wheel brake via the respective pressure build-up valve.

6. The braking system according to claim 1, wherein the pressure side of the brake pump is fluidically connected to the brake pressure source via the isolation valve, and the intake side of the brake pump is fluidically connected to the brake pressure source via the further isolation valve.

7. The braking system according to claim 1, wherein the brake pressure control devices are connected to different electrical circuits, wherein the valve device switches from the first brake pressure control device to a second of the brake pressure control devices in the absence of current in a first of the electrical circuits assigned to a first of the brake pressure control devices.

8. The braking system according to claim 1, wherein the brake pressure control devices comprise at least three brake pressure control devices, and the valve device is multistage, wherein a first stage of the valve device is fluidically connected to the at least one brake pressure source on the input side and to the first brake pressure control device and a second stage of the valve device on the output side, and the second stage of the valve device is connected to the first stage of the valve device on the input side and to the second brake pressure control device and a third of the brake pressure control devices on the output side.

9. The braking system according to claim 1, wherein the brake pressure control devices are present as equivalent parts.

10. A method for operating a braking system for a motor vehicle, comprising:
a braking system, wherein the braking system has at least one brake pressure source and at least one wheel brake, wherein the at least one wheel brake is fluidically connected to the at least one brake pressure source via several brake pressure control devices, which are fluidically connected in parallel, wherein each of the brake pressure control devices has at least one pressure build-up valve and at least one pressure reduction valve, and that the brake pressure control devices are fluidically connected to the at least one brake pressure source via a common valve device, wherein the valve device always fluidically connects one of the brake pressure control devices to the at least one brake pressure source.

11. The braking system according to claim 2, wherein the wheel brake is fluidically connected to the brake pressure source via the brake circuit of the brake pressure control device, and a further wheel brake is fluidically connected to the brake pressure source via the further brake circuit of the brake pressure control devices.

12. The braking system according to claim 2, wherein, for each of the brake pressure control devices, the pressure reduction valve is fluidically connected to the at least one brake pressure source via an isolation valve of the respective brake pressure control device, and the pressure reduction valve is fluidically connected to the at least one brake pressure source via a further isolation valve of the respective brake pressure control device.

13. The braking system according to claim 3, wherein, for each of the brake pressure control devices, the pressure reduction valve is fluidically connected to the at least one brake pressure source via an isolation valve of the respective brake pressure control device, and the pressure reduction valve is fluidically connected to the at least one brake pressure source via a further isolation valve of the respective brake pressure control device.

14. The braking system according to claim 2, wherein each of the brake pressure control devices has at least one brake pump, the intake side of which is fluidically connected to the wheel brake via the respective pressure reduction valve, and the pressure side of which is fluidically connected to the wheel brake via the respective pressure build-up valve.

15. The braking system according to claim 3, wherein each of the brake pressure control devices has at least one brake pump, the intake side of which is fluidically connected to the wheel brake via the respective pressure reduction valve, and the pressure side of which is fluidically connected to the wheel brake via the respective pressure build-up valve.

16. The braking system according to claim 4, wherein each of the brake pressure control devices has at least one brake pump, the intake side of which is fluidically connected to the wheel brake via the respective pressure reduction valve, and the pressure side of which is fluidically connected to the wheel brake via the respective pressure build-up valve.

17. The braking system according to claim 2, wherein the pressure side of the brake pump is fluidically connected to the brake pressure source via the isolation valve, and the intake side of the brake pump is fluidically connected to the brake pressure source via the further isolation valve.

18. The braking system according to claim 3, wherein the pressure side of the brake pump is fluidically connected to the brake pressure source via the isolation valve, and the intake side of the brake pump is fluidically connected to the brake pressure source via the further isolation valve.

19. The braking system according to claim 4, wherein the pressure side of the brake pump is fluidically connected to the brake pressure source via the isolation valve, and the intake side of the brake pump is fluidically connected to the brake pressure source via the further isolation valve.

20. The braking system according to claim 5, wherein the pressure side of the brake pump is fluidically connected to the brake pressure source via the isolation valve, and the intake side of the brake pump is fluidically connected to the brake pressure source via the further isolation valve.
